(19) United States
(12) Patent Application Publication
(10) Pub. No.: US 2022/0279299 A1
(43) Pub. Date: Sep. 1, 2022

(54) QUANTIZATION OF SPATIAL AUDIO DIRECTION PARAMETERS

(71) Applicant: Nokia Technologies Oy, Espoo (FI)

(72) Inventor: Adriana VASILACHE, Tampere (FI)

(21) Appl. No.: 17/628,792

(22) PCT Filed: Jun. 15, 2020
(86) PCT No.: PCT/FI2020/050424

§ 371 Date: Jan. 20, 2022

(30) Foreign Application Priority Data
Jul. 31, 2019 (GB) 1910893.5

(51) Int. Cl. H04S 7/00; G10L 19/035; G10L 19/008; H04S 3/00

(52) U.S. Cl. CPC H04S 7/30; G10L 19/035; G10L 19/008; H04S 3/008; H04S 2420/03; H04S 2400/01

(57) ABSTRACT

There is disclosed inter alia an apparatus for spatial audio signal encoding configured to derive for each of a plurality of audio direction parameters a corresponding derived audio direction parameter comprising an elevation value and an azimuth value. Each derived audio direction parameter is rotated by the azimuth value of an audio direction parameter in the first position of the plurality of audio direction parameters. The position of some of the audio direction parameters are changed followed by determining for each of the plurality audio direction parameters a difference between each audio direction parameter and a corresponding rotated derived audio direction parameter. The difference for each of the plurality of audio direction parameters is then quantised.

### FIELD

The present application relates to apparatus and methods for sound-field related parameter encoding, but not exclusively for direction related parameter encoding for an audio encoder and decoder.

### BACKGROUND

Parametric spatial audio processing is a field of audio signal processing where the spatial aspect of the sound is described using a set of parameters. For example, in parametric spatial audio capture from microphone arrays, it is a typical and an effective choice to estimate from the microphone array signals a set of parameters such as directions of the sound in frequency bands, and the ratios between the directional and non-directional parts of the captured sound in frequency bands. These parameters are known to well describe the perceptual spatial properties of the captured sound at the position of the microphone array. These parameters can be utilized in synthesis of the spatial sound accordingly, for headphones binaurally, for loudspeakers, or to other formats, such as Ambisonics.

The directions and direct-to-total energy ratios in frequency bands are thus a parameterization that is particularly effective for spatial audio capture.

A parameter set consisting of a direction parameter in frequency bands and an energy ratio parameter in frequency bands (indicating the directionality of the sound) can be also utilized as the spatial metadata for an audio codec. For example, these parameters can be estimated from microphone-array captured audio signals, and for example a stereo signal can be generated from the microphone array signals to be conveyed with the spatial metadata. The stereo signal could be encoded, for example, with an AAC encoder. A decoder can decode the audio signals into PCM signals, and process the sound in frequency bands (using the spatial metadata) to obtain the spatial output, for example a binaural output.

The aforementioned solution is particularly suitable for encoding captured spatial sound from microphone arrays (e.g., in mobile phones, VR cameras, stand-alone microphone arrays). However, it may be desirable for such an encoder to have also other input types than microphone-array captured signals, for example, loudspeaker signals, audio object signals, or Ambisonic signals.

Analysing first-order Ambisonics (FOA) inputs for spatial metadata extraction has been thoroughly documented in scientific literature related to Directional Audio Coding (DirAC) and Harmonic planewave expansion (Harpex). This is since there exist microphone arrays directly providing a FOA signal (more accurately: its variant, the B-format signal), and analysing such an input has thus been a point of study in the field.

A further input for the encoder may be also multi-channel loudspeaker input, such as 5.1 or 7.1 channel surround inputs, or a Meta Data Assisted Spatial Audio (MASA) format input.

However, with respect to input audio objects types to an encoder there may be accompanying metadata which comprises directional components of each audio object within a physical space. These directional components may comprise an elevation and azimuth of an audio object's position within the space.

### SUMMARY

There is provided according to a first aspect a method for spatial audio signal encoding comprising: deriving for each of the plurality of audio direction parameters, wherein each parameter comprises an elevation value and an azimuth value and wherein each parameter has an ordered position, a corresponding derived audio direction parameter comprising an elevation value and an azimuth value; rotating each derived audio direction parameter by the azimuth value of an audio direction parameter in the first position of the plurality of audio direction parameters; changing the ordered position of an audio direction parameter to a further position coinciding with a position of a rotated derived audio direction parameter when the azimuth value of the audio direction parameter is closest to the azimuth value of the further rotated derived audio direction parameter compared to the azimuth values of other rotated derived audio direction parameters, followed by determining for each of the plurality audio direction parameters a difference between each audio direction parameter and a corresponding rotated derived audio direction parameter; and quantising the difference for each of the plurality of audio direction parameters.

The azimuth value of each derived audio direction parameter may correspond with a position of a plurality of positions around the circumference of a circle.

The plurality of positions around the circumference of the circle may be evenly distributed along the 360 degrees of the circle, and wherein the number of positions around the circumference of the circle is determined by the number of audio direction parameters.

Rotating each derived audio direction parameter by the azimuth value of a first audio direction parameter of the plurality of audio direction parameters may comprise: adding the azimuth value of the first audio direction parameter to the azimuth value of each derived audio direction parameter, wherein the elevation value of each derived audio direction parameter is set to zero.

The method may further comprise: scalar quantising the azimuth value of the first audio direction parameter; and indexing the positions of the audio direction parameters after the changing by assigning an index to a permutation of indices representing the order of the positions of the audio direction parameters.

Determining for each of the plurality of audio direction parameters a difference between each audio direction parameter and a corresponding rotated derived audio direction parameter may comprise determining for each of the plurality of audio direction parameters a difference audio direction parameter based on at least; determining a difference between the first positioned audio direction parameter and the first positioned rotated derived audio direction parameter, and/or determining a difference between a further audio direction parameter and a rotated derived audio direction parameter, wherein the position of the further audio direction parameter is unchanged, and/or determining a difference between a yet further audio direction parameter and a rotated derived audio direction parameter wherein the position of the yet further audio direction parameter has been changed to the position of the rotated derived audio direction parameter.

Determining a difference between an audio direction parameter and a corresponding rotated derived audio direction parameter may comprise: determining the difference between an azimuth value of the audio direction parameter and an azimuth value of the corresponding rotated derived audio direction parameter; and determining the difference between an elevation value of the audio direction parameter and an elevation value of the corresponding rotated derived audio direction parameter.

Changing the position of an audio direction parameter to a further position may apply to any audio direction parameter but the first positioned audio direction parameter.

Quantising the difference audio direction parameter for each of the plurality of audio direction parameters may comprise quantising the difference audio direction parameter for each of the plurality of audio direction parameters as a vector, wherein the vector is indexed to a codebook may comprise a plurality of indexed elevation values and indexed azimuth values.

The plurality of indexed elevation values and indexed azimuth values may be points on a grid arranged in a form of a sphere, wherein the spherical grid may be formed by covering the sphere with smaller spheres, wherein the smaller spheres define the points of the spherical grid.

There is according to a second aspect a method for spatial audio signal decoding comprising: decoding an index to provide a quantized azimuth value of an audio direction parameter in a first position of a plurality of ordered audio direction parameters, wherein each parameter comprises an elevation value and an azimuth value; deriving for each of the plurality of audio direction parameters a corresponding derived audio direction parameter comprising an elevation value and an azimuth value; rotating each derived audio direction parameter by the azimuth value of the audio direction parameter in the first position of the plurality of audio direction parameters; decoding an index to provide for each audio direction parameter a quantised difference between an audio direction parameter and their corresponding derived audio direction parameter; forming, for each audio direction parameter, a quantized audio direction parameter by adding the quantised difference to their corresponding derived audio direction parameter; and decoding an index representing an order for the plurality of quantized audio direction parameters and reordering the positions of the plurality of quantized audio direction parameters according to the order.

The azimuth value of each derived audio direction parameter may correspond with a position of a plurality of positions around the circumference of a circle.

The plurality of positions around the circumference of the circle may be evenly distributed along the 360 degrees of the circle, and the number of positions around the circumference of the circle may be determined by the number of audio direction parameters.

Rotating each derived audio direction parameter by the quantized azimuth value of a first audio direction parameter of the plurality of audio direction parameters may comprise: adding the quantized azimuth value of the first audio direction parameter to the azimuth value of each derived audio direction parameter, wherein the elevation value of each derived audio direction parameter is set to zero.

The index to provide for each audio direction parameter a quantised difference between an audio direction parameter and their corresponding derived audio direction parameter may be an index to a codebook comprising a plurality of indexed elevation values and indexed azimuth values

The plurality of indexed elevation values and indexed azimuth values may be points on a grid arranged in a form of a sphere, the spherical grid may be formed by covering the sphere with smaller spheres, the smaller spheres may define the points of the spherical grid.

There is according to a third aspect an apparatus for spatial audio signal encoding comprising: derive for each of the plurality of audio direction parameters, wherein each parameter comprises an elevation value and an azimuth value and wherein each parameter has an ordered position, a corresponding derived audio direction parameter comprising an elevation value and an azimuth value; rotate each derived audio direction parameter by the azimuth value of an audio direction parameter in the first position of the plurality of audio direction parameters; change the ordered position of an audio direction parameter to a further position coinciding with a position of a rotated derived audio direction parameter when the azimuth value of the audio direction parameter is closest to the azimuth value of the further rotated derived audio direction parameter compared to the azimuth values of other rotated derived audio direction parameters, followed by the apparatus being configured to determine for each of the plurality audio direction parameters a difference between each audio direction parameter and a corresponding rotated derived audio direction parameter; and quantise the difference for each of the plurality of audio direction parameters.

The azimuth value of each derived audio direction parameter may correspond with a position of a plurality of positions around the circumference of a circle.

The plurality of positions around the circumference of the circle may be evenly distributed along the 360 degrees of the circle, and wherein the number of positions around the circumference of the circle may be determined by the number of audio direction parameters.

The apparatus configured to rotate each derived audio direction parameter by the azimuth value of a first audio direction parameter of the plurality of audio direction parameters may be configured to: add the azimuth value of the first audio direction parameter to the azimuth value of each derived audio direction parameter, wherein the elevation value of each derived audio direction parameter is set to zero.

The apparatus may be further configured to: scalar quantise the azimuth value of the first audio direction parameter; and index the positions of the audio direction parameters after the changing by assigning an index to a permutation of indices representing the order of the positions of the audio direction parameters.

The apparatus configured to determine for each of the plurality of audio direction parameters a difference between each audio direction parameter and a corresponding rotated derived audio direction parameter may be configured to determine for each of the plurality of audio direction parameters a difference audio direction parameter maybe based on at least; determine a difference between the first positioned audio direction parameter and the first positioned rotated derived audio direction parameter, and/or determine a difference between a further audio direction parameter and a rotated derived audio direction parameter, wherein the position of the further audio direction parameter is unchanged, and/or determining a difference between a yet further audio direction parameter and a rotated derived audio direction parameter wherein the position of the yet further audio direction parameter has been changed to the position of the rotated derived audio direction parameter.

The apparatus configured to determine a difference between an audio direction parameter and a corresponding rotated derived audio direction parameter may be configured to: determine the difference between an azimuth value of the audio direction parameter and an azimuth value of the corresponding rotated derived audio direction parameter; and determine the difference between an elevation value of the audio direction parameter and an elevation value of the corresponding rotated derived audio direction parameter.

The apparatus configured to change the position of an audio direction parameter to a further position may apply to any audio direction parameter but the first positioned audio direction parameter.

The apparatus configured to quantise the difference audio direction parameter for each of the plurality of audio direction parameters may be configured to quantise the difference audio direction parameter for each of the plurality of audio direction parameters as a vector, wherein the vector is indexed to a codebook comprising a plurality of indexed elevation values and indexed azimuth values.

The plurality of indexed elevation values and indexed azimuth values may be points on a grid arranged in a form of a sphere, wherein the spherical grid may be formed by covering the sphere with smaller spheres, wherein the smaller spheres define the points of the spherical grid.

There is according to a fourth aspect an apparatus for spatial audio signal decoding configured to: decode an index to provide a quantized azimuth value of an audio direction parameter in a first position of a plurality of ordered audio direction parameters, wherein each parameter comprises an elevation value and an azimuth value; derive for each of the plurality of audio direction parameters a corresponding derived audio direction parameter comprising an elevation value and an azimuth value; rotate each derived audio direction parameter by the azimuth value of the audio direction parameter in the first position of the plurality of audio direction parameters; decode an index to provide for each audio direction parameter a quantised difference between an audio direction parameter and their corresponding derived audio direction parameter; form, for each audio direction parameter, a quantized audio direction parameter by adding the quantised difference to their corresponding derived audio direction parameter; and decode an index representing an order for the plurality of quantized audio direction parameters and reordering the positions of the plurality of quantized audio direction parameters according to the order.

The azimuth value of each derived audio direction parameter may correspond with a position of a plurality of positions around the circumference of a circle.

The plurality of positions around the circumference of the circle may be evenly distributed along the 360 degrees of the circle, and wherein the number of positions around the circumference of the circle may be determined by the number of audio direction parameters.

The apparatus configured to rotate each derived audio direction parameter by the quantized azimuth value of a first audio direction parameter of the plurality of audio direction parameters may be configured to: add the quantized azimuth value of the first audio direction parameter to the azimuth value of each derived audio direction parameter, wherein the elevation value of each derived audio direction parameter is set to zero.

The index to provide for each audio direction parameter a quantised difference between an audio direction parameter and their corresponding derived audio direction parameter may be an index to a codebook comprising a plurality of indexed elevation values and indexed azimuth values.

The plurality of indexed elevation values and indexed azimuth values maybe points on a grid arranged in a form of a sphere, wherein the spherical grid may be formed by covering the sphere with smaller spheres, wherein the smaller spheres define the points of the spherical grid.

There is according to fifth aspect an apparatus for spatial audio coding comprising at least one processor and at least one memory including computer program code, the at least one memory and the computer program code configured to, with the at least one processor, cause the apparatus to: derive for each of the plurality of audio direction parameters, wherein each parameter comprises an elevation value and an azimuth value and wherein each parameter has an ordered position, a corresponding derived audio direction parameter comprising an elevation value and an azimuth value; rotate each derived audio direction parameter by the azimuth value of an audio direction parameter in the first position of the plurality of audio direction parameters; change the ordered position of an audio direction parameter to a further position coinciding with a position of a rotated derived audio direction parameter when the azimuth value of the audio direction parameter is closest to the azimuth value of the further rotated derived audio direction parameter compared to the azimuth values of other rotated derived audio direction parameters, followed by the apparatus being configured to determine for each of the plurality audio direction parameters a difference between each audio direction parameter and a corresponding rotated derived audio direction parameter; and quantise the difference for each of the plurality of audio direction parameters.

There is according to sixth aspect an apparatus for spatial audio coding comprising at least one processor and at least one memory including computer program code, the at least one memory and the computer program code configured to, with the at least one processor, cause the apparatus to: decode an index to provide a quantized azimuth value of an audio direction parameter in a first position of a plurality of ordered audio direction parameters, wherein each parameter comprises an elevation value and an azimuth value; derive for each of the plurality of audio direction parameters a corresponding derived audio direction parameter comprising an elevation value and an azimuth value; rotate each derived audio direction parameter by the azimuth value of the audio direction parameter in the first position of the plurality of audio direction parameters; decode an index to provide for each audio direction parameter a quantised difference between an audio direction parameter and their corresponding derived audio direction parameter; form, for each audio direction parameter, a quantized audio direction parameter by adding the quantised difference to their corresponding derived audio direction parameter; and decode an index representing an order for the plurality of quantized audio direction parameters and reordering the positions of the plurality of quantized audio direction parameters according to the order.

A computer program product stored on a medium may cause an apparatus to perform the method as described herein.

An electronic device may comprise apparatus as described herein.

A chipset may comprise apparatus as described herein.

Embodiments of the present application aim to address problems associated with the state of the art.

### SUMMARY OF THE FIGURES

For a better understanding of the present application, reference will now be made by way of example to the accompanying drawings in which:

FIG. 1 shows schematically a system of apparatus suitable for implementing some embodiments;

FIG. 2 shows schematically the audio object encoder as shown in FIG. 1 according to some embodiments;

FIG. 3a shows schematically the a spherical quantizer & indexer implemented as shown in FIG. 2 according to some embodiments;

FIG. 3b shows schematically the spherical de-indexer as shown in FIG. 5 according to some embodiments;

FIG. 3c shows schematically example sphere location configurations as used in the spherical quantizer & indexer and the spherical de-indexer as shown in FIGS. 3a and 3b according to some embodiments;

FIG. 4 shows a flow diagram of the operation of the audio object encoder as shown in FIG. 2 according to some embodiments;

FIG. 5 shows schematically the audio object decoder as shown in FIG. 1 according to some embodiments;

FIG. 6 shows a flow diagram of generating a direction index based on an input direction parameter in further detail;

FIG. 7 shows a flow diagram of an example operation of quantizing the direction parameter to obtain a direction index;

FIG. 8 shows a flow diagram of the operation of the audio object decoder as shown in FIG. 5 according to some embodiments; and

FIG. 9 shows schematically an example device suitable for implementing the apparatus shown.

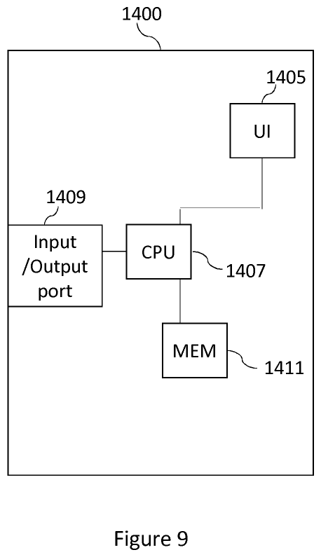

### EMBODIMENTS OF THE APPLICATION

The following describes in further detail suitable apparatus and possible mechanisms for the provision of effective spatial analysis derived metadata parameters for multi-channel input format audio signals and input audio objects. In the following discussions multi-channel system is discussed with respect to a multi-channel microphone implementation. However as discussed above the input format may be any suitable input format, such as multi-channel loudspeaker, ambisonic (FOA/HOA) etc. It is understood that in some embodiments the channel location is based on a location of the microphone or is a virtual location or direction. Furthermore, the output of the example system is a multi-channel loudspeaker arrangement. However, it is understood that the output may be rendered to the user via means other than loudspeakers. Furthermore, the multi-channel loudspeaker signals may be generalised to be two or more playback audio signals.

As discussed previously spatial metadata parameters such as direction and direct-to-total energy ratio (or diffuseness-ratio, absolute energies, or any suitable expression indicating the directionality/non-directionality of the sound at the given time-frequency interval) parameters in frequency bands are particularly suitable for expressing the perceptual properties of natural sound fields. Synthetic sound scenes such as 5.1 loudspeaker mixes commonly utilize audio effects and amplitude panning methods that provide spatial sound that differs from sounds occurring in natural sound fields. In particular, a 5.1 or 7.1 mix may be configured such that it contains coherent sounds played back from multiple directions. For example, it is common that some sounds of a 5.1 mix perceived directly at the front are not produced by a centre (channel) loudspeaker, but for example coherently from left and right front (channels) loudspeakers, and potentially also from the centre (channel) loudspeaker. The spatial metadata parameters such as direction(s) and energy ratio(s) do not express such spatially coherent features accurately. As such other metadata parameters such as coherence parameters may be determined from analysis of the audio signals to express the audio signal relationships between the channels.

In addition to multi-channel input format audio signals an encoding system may also be required to encode audio objects representing various sound sources within a physical space. Each audio object can be accompanied, whether it is in the form of metadata or some other mechanism, by directional data in the form of azimuth and elevation values which indicate the position of an audio object within a physical space.

As expressed above an example of the incorporation of direction information for audio objects as metadata is to use determined azimuth and elevation values.

The concept it thus an attempt to determine a direction parameter for audio objects and to index the parameter based on a practical sphere covering based distribution of the directions in order to define a more uniform distribution of directions.

The proposed directional index for audio objects may then be used alongside a downmix signal (‘channels’), to define a parametric immersive format that can be utilized, e.g., for the Immersive Voice and Audio Service (IVAS) codec. Alternatively and in addition, the spherical grid format can be used in the codec to quantize directions.

The concept furthermore discusses the decoding of such indexed direction parameters to produce quantised directional parameters which can be used in synthesis of spatial audio based on audio object sound-field related parameterization.

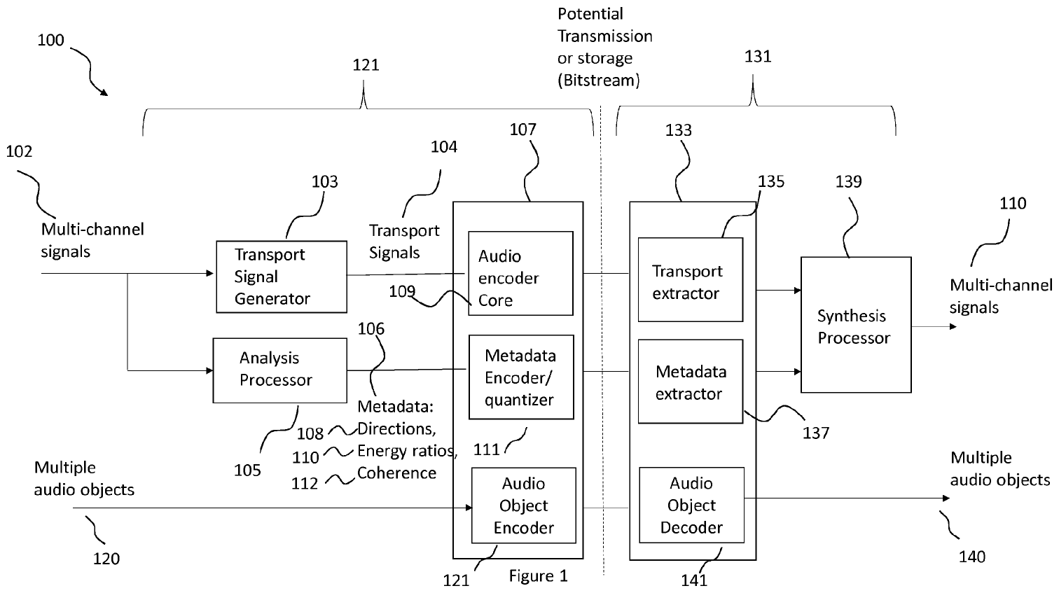

With respect to FIG. 1 an example apparatus and system for implementing embodiments of the application are shown. The system 100 is shown with an ‘analysis’ part 121 and a ‘synthesis’ part 131. The ‘analysis’ part 121 is the part from receiving the multi-channel loudspeaker signals up to an encoding of the metadata and downmix signal and the ‘synthesis’ part 131 is the part from a decoding of the encoded metadata and downmix signal to the presentation of the re-generated signal (for example in multi-channel loudspeaker form).

The input to the system 100 and the ‘analysis’ part 121 is the multi-channel signals 102. In the following examples a microphone channel signal input is described, however any suitable input (or synthetic multi-channel) format may be implemented in other embodiments.

The multi-channel signals are passed to a downmixer 103 and to an analysis processor 105.

In some embodiments the downmixer 103 is configured to receive the multi-channel signals and downmix the signals to a determined number of channels and output the downmix signals 104. For example the downmixer 103 may be configured to generate a 2 audio channel downmix of the multi-channel signals. The determined number of channels may be any suitable number of channels. In some embodiments the downmixer 103 is optional and the multi-channel signals are passed unprocessed to an encoder 107 in the same manner as the downmix signal are in this example.

In some embodiments the analysis processor 105 is also configured to receive the multi-channel signals and analyse the signals to produce metadata 106 associated with the multi-channel signals and thus associated with the downmix signals 104. The analysis processor 105 may be configured to generate the metadata which may comprise, for each time-frequency analysis interval, a direction parameter 108, an energy ratio parameter 110, a coherence parameter 112, and a diffuseness parameter 114. The direction, energy ratio and diffuseness parameters may in some embodiments be considered to be spatial audio parameters. In other words the spatial audio parameters comprise parameters which aim to characterize the sound-field created by the multi-channel signals (or two or more playback audio signals in general).

In some embodiments the parameters generated may differ from frequency band to frequency band. Thus, for example in band X all of the parameters are generated and transmitted, whereas in band Y only one of the parameters is generated and transmitted, and furthermore in band Z no parameters are generated or transmitted. A practical example of this may be that for some frequency bands such as the highest band some of the parameters are not required for perceptual reasons. The downmix signals 104 and the metadata 106 may be passed to an encoder 107.

The encoder 107 may comprise an IVAS stereo core 109 which is configured to receive the downmix (or otherwise) signals 104 and generate a suitable encoding of these audio signals. The encoder 107 can in some embodiments be a computer (running suitable software stored on memory and on at least one processor), or alternatively a specific device utilizing, for example, FPGAs or ASICs. The encoding may be implemented using any suitable scheme. The encoder 107 may furthermore comprise a metadata encoder or quantizer 109 which is configured to receive the metadata and output an encoded or compressed form of the information. Additionally, there may also be an audio object encoder 121 within the encoder 107 which in embodiments may be arranged to encode data (or metadata) associated with the multiple audio objects along the input 120. The data associated with the multiple audio objects may comprise at least in part directional data. In some embodiments the encoder 107 may further interleave, multiplex to a single data stream or embed the metadata within encoded downmix signals before transmission or storage shown in FIG. 1 by the dashed line. The multiplexing may be implemented using any suitable scheme.

In the decoder side, the received or retrieved data (stream) may be received by a decoder/demultiplexer 133. The decoder/demultiplexer 133 may demultiplex the encoded streams and pass the audio encoded stream to a downmix extractor 135 which is configured to decode the audio signals to obtain the downmix signals. Similarly, the decoder/demultiplexer 133 may comprise a metadata extractor 137 which is configured to receive the encoded metadata and generate metadata. Additionally, the decoder/demultiplexer 133 may also comprise an audio object decoder 141 which can be configured to receive encoded data associated with multiple audio objects and accordingly decode such data to produce the corresponding decoded data 140. The decoder/demultiplexer 133 can in some embodiments be a computer (running suitable software stored on memory and on at least one processor), or alternatively a specific device utilizing, for example, FPGAs or ASICs.

The decoded metadata and downmix audio signals may be passed to a synthesis processor 139.

The system 100 ‘synthesis’ part 131 further shows a synthesis processor 139 configured to receive the downmix and the metadata and re-creates in any suitable format a synthesized spatial audio in the form of multi-channel signals 110 (these may be multichannel loudspeaker format or in some embodiments any suitable output format such as binaural or Ambisonics signals, depending on the use case) based on the downmix signals and the metadata.

The is an additional input 120 may specifically comprise directional data associated with multiple audio objects. One particular example of such a use case is a teleconference scenario where participants are positioned around a table. Each audio object may represent audio data associated with each participant. In particular the audio object may have positional data associated with each participant. The data associated with the audio objects is depicted in FIG. 1 as being passed to the audio object encoder 121.

Returning to FIG. 1, it was noted that the system 100 can be configured to accept multiple audio objects along the input 120, and that each audio object can have associated directional data. The audio objects including associated directional data may then be passed to an audio object encoder 121 for encoding and quantization. To that extent the directional data associated with each audio object can also be expressed in terms of azimuth φ and elevation θ, where the azimuth value and elevation value of each audio object indicates the position of the object in space at any point in time. The azimuth and elevation values can be updated on a time frame by time frame basis which does not necessarily have to coincide with the time frame resolution of the directional metadata parameters associated with the multi-channel audio signals.

In general, the directional information for N active input audio objects to the audio object encoder 121 may be expressed in the form of P_{q}=(θ_{q}, ϕ_{q}), q=0: N−1, where P_{q} is the directional information of an audio object with index q having a two dimensional vector comprising elevation θ value and the azimuth φ value.

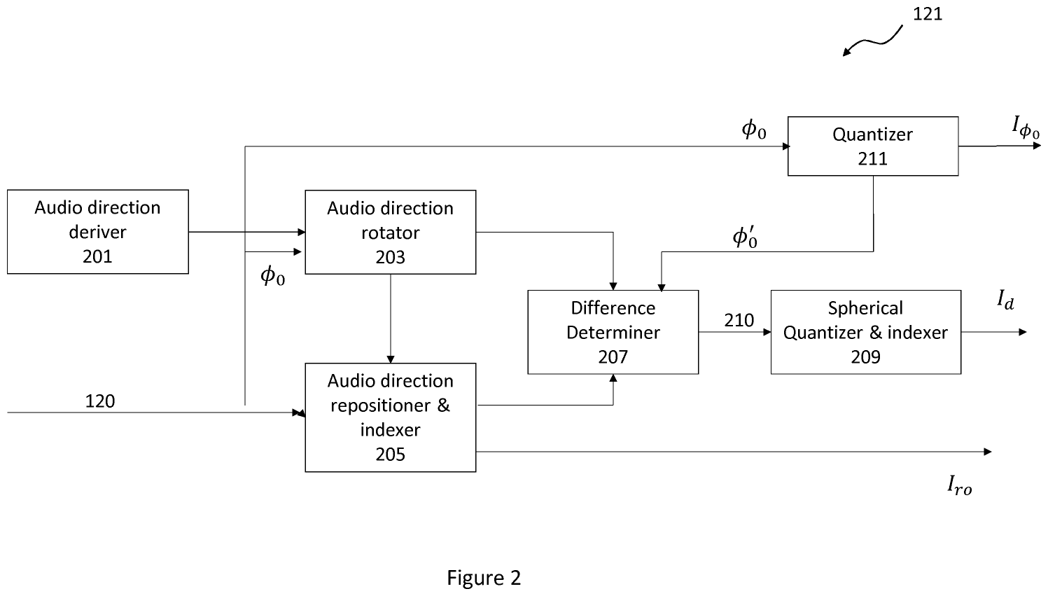

The concept herein is to find vector difference between the directional information of an audio object and a “template” audio direction parameter derived for the audio object, and then to quantise the vector difference using a spherical quantization scheme, in this regard FIG. 2 depicts some of the functionality of the audio object encoder 121 in more detail.

The audio object encoder 121 can comprise an audio object direction deriver 201 arranged to derive a suitable “template” audio direction parameter for each audio object. In embodiments this may be derived as a N dimensional vector having as elements N derived audio direction parameters corresponding to the N audio objects. These derived audio direction parameters may be derived from the viewpoint of considering audio objects being distributed around the circumference of a circle. In particular, the derived audio direction parameters may be considered from the viewpoint of the audio objects directions being evenly distributed as N equidistant points around a unit circle.

In the following description the N derived audio direction parameters are disclosed as being formed into a vector structure (termed the vector, SP) with each element corresponding to the derived audio direction parameter for one of the N audio objects. However, it is to be understood that the following disclosure can be applied by considering the derived audio direction parameters as a collection of indexed parameters which do not need to be structured in the form of a vector.

The audio object direction deriver 201 can be configured to derive a “template” derived audio direction vector SP having N two dimensional elements, whereby each element represents the azimuth and elevation associated with an audio object. The vector SP may then be initialised by setting the azimuth and elevation value of each element such that the N audio objects are evenly distributed around a unit circle. This can be realised by initializing each audio object direction element within the vector to have an elevation value of zero and an azimuth value of

$$q \cdot \frac{360}{N}$$

where q is the index of the associated audio object. Therefore, the vector SP can be written for the N audio objects as

$$S P = ( 0 , 0 ; 0 , \frac{360}{N} ; 0 , 2 \cdot \frac{360}{N} ; … ; 0 , ( N - 1 ) \cdot \frac{360}{N} )$$

In other words, the SP vector can be initialised so that the directional information of each audio objects (the derived audio direction parameters) are presumed to be distributed evenly along a unit circle starting at an azimuth value of 0°.

In other embodiments the SP vector may be initialised with an elevation value which is not zero. For instance, the same elevation value can be used for each derived audio direction element of the SP vector. In this case the SP vector would no longer be in the horizontal plane, but in an inclined plane.

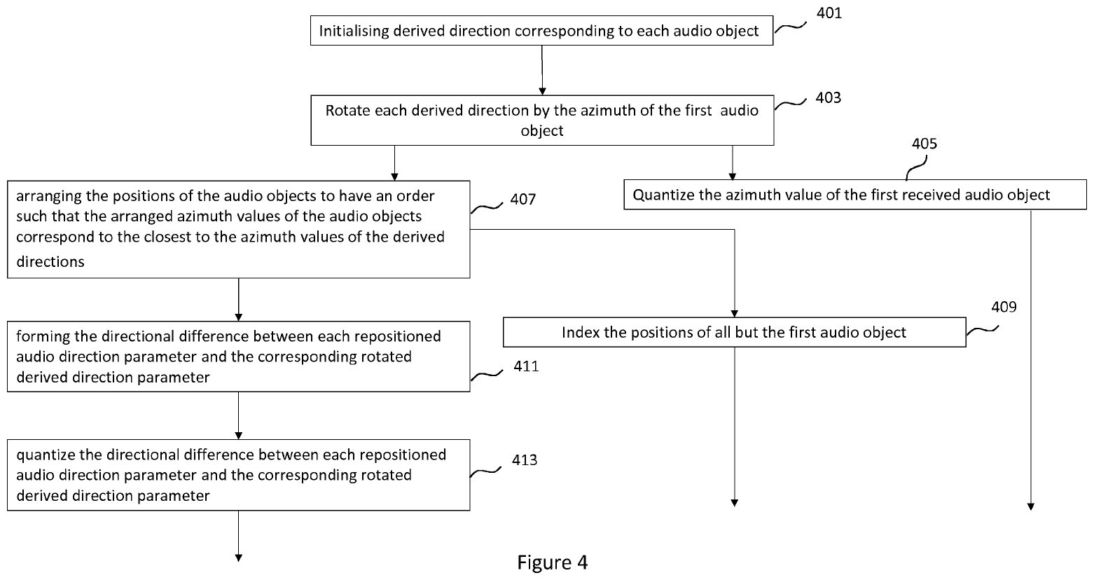

This processing step of initialising the derived audio direction parameter associated with each audio object is shown as processing step 401 in FIG. 4.

The derived audio direction SP vector having elements comprising the derived audio direction parameters corresponding to the audio objects may then be passed to the audio direction rotator 203 in the audio object encoder 121. The audio direction rotator 203 is also depicted as receiving the audio objects 120. In particular the audio direction rotator 203 may then use the audio direction parameter of the first audio object in subsequent processing by rotating each derived direction within the SP vector by the azimuth value of the first component ϕ₀ from the first received audio object P₀. That is each azimuth component of each derived audio direction parameter within the derived vector SP may be rotated by adding the value of the first azimuth component ϕ₀ of the first received audio object. In terms of the SP vector this operation results in each element having the following form

$$= ( 0 , 0 + {ϕ}_{0} ; 0 , \frac{360}{N} + {ϕ}_{0} ; 0 , 2 \cdot \frac{360}{N} + {ϕ}_{0} ; … ; 0 , ( N - 1 ) \cdot \frac{360}{N} + {ϕ}_{0} ) .$$

For embodiments which are deployed having an elevation angle of zero for the derived audio direction vector SP the vector SP can be expressed solely in terms of the azimuth angles [symbol] =(\hat{ϕ}₀; \hat{ϕ}₁, \hat{ϕ}₂; . . . ; ϕ̅_{N-1}) where ϕ̅ᵢ is the rotated azimuth component given by

$$i \cdot \frac{360}{N} + {ϕ}_{0}$$

and [symbol] is the rotated derived audio direction vector SP vector.

For the embodiments which initialise the elevation direction components of the derived vector SP to some initial elevation value there may also be a rotation applied to the derived direction elevation values of the derived vector SP. For instance, in these embodiments each element of the derived vector SP may be rotated by first direction component from the first received audio object θₒ.

As a result of this step the rotated derived audio direction vector [symbol] is now aligned to the direction of the first audio object on the unit circle.

Returning to the process diagram of FIG. 4, this step can be represented as the processing step 403.

The audio object encoder 121 may then be arranged to quantize and encode the above rotated derived audio direction vector [symbol] . In embodiments this can simply comprise quantizing the rotation angle ϕ₀ to a particular resolution by the quantizer 211. For example, a linear quantizer with a resolution of 2.5 degrees (that is 5 degrees between consecutive points on the linear scale) results in 72 linear quantization levels. It is to be noted that the (unrotated) derived audio direction vector SP is dependent on the number of active audio objects N and this factor can be either passed to the decoder or otherwise agreed with the encoder.

For the embodiments which initialise the elevation direction components of the derived vector SP to some initial elevation value the first received audio object θₒ may also be scalar quantized

The step of quantizing the rotation angle is shown in FIG. 4 as processing step 405.

The audio object encoder 121 can also comprise an audio direction repositioner & indexer 205 configured to reorder the position of the received audio objects in order to align more closely to the rotated derived audio directions of the elements of the rotated derived audio direction vector [symbol] . This may be achieved by reordering the position of the audio objects such that the azimuth value of each reordered audio object is aligned with the position of the element in the vector [symbol] having the closest azimuth value. The reordered positions of each audio object may then be encoded as a permutation index. This process may comprise the following algorithmic steps:

1. Assigning an index to each active audio object in the order which they were received, as a vector this may be expressed as I=(i₀, i₁, i₂ . . . i_{N-1}).

2. Rearrange all but the first index i₀, so that an index iᵢ which is currently in position i is moved to position j if the azimuth angle associated with the audio object ϕᵢ is closest to the azimuth angle \hat{ϕ}ⱼ at position j out of all azimuth angles in the rotated derived vector [symbol] .

For an example comprising four active audio objects. The SP codevector may be initialised evenly along the unit circle as SP=(0, 0; 0, 90; 0, 180; 0, 270). The directional data associated with the four audio objects ((θ₀, ϕ₀); (θᵣ, ϕ₁); . . . (θ_{N-1}, ϕ_{N-1})) may be received as ((0,130); (0,210); (0,39); (0,310) in which the first ϕ₀ is given as 130 degrees. In this particular example the rotated azimuth angles in the vector [symbol] are given by (0+130, 90+130, 180+130, 270+130)=(130; 220; 310; 400)=(130, 220, 310, 40). In this example the second audio object with azimuth angle 210 closest to the second azimuth angle in the vector [symbol] , the third audio object with azimuth angle 30 is closest to the fourth azimuth angle in the vector [symbol] and the fourth audio object with azimuth angle 310 is closest to the third azimuth angle in the vector [symbol] . Therefore, in this case the reordered audio object index vector is Í=i₀, i₁, i₃, i₂).

3. The reordered audio object indices may then be indexed according to the particular permutation of the indices. Each particular permutation of indices of the reordered audio objects may be assigned an index value. However, it is to be understood that the first index position of the reordered audio objects is not part of the permutation of indices as the index of the first element in the vector does not change. That is first audio object always remains in the first position because this is the audio object towards which the elements of the derived audio direction vector SP is rotated. Accordingly, there are a possible (N−1)! permutations of indices of the reordered audio objects which can be represented within the bounds of log₂((N−1)!) bits.

Returning to the above example of a system having 4 active audio objects it is only the indices of i₃, i₁, i₂ that are required to be indexed. The indexing for the possible permutations of indices of the reordered audio objects for the above demonstrative example may take the following form

| Index | order of indices of re ordered audio objects |
|---|---|
| 0 | iᵢ, i₂, i₃ |
| 1 | i₁, i₃, i₂ |
| 2 | i₂, i₁, i₃ |
| 3 | i₂, i₃, i₁ |
| 4 | i₃, i₁, i₂ |
| 5 | i₃, i₂, i₁ |

Therefore, in order to represent the reordered audio objects it may be required to transmit the azimuth of the first object ϕ₀, in order to represent the rotated derived audio parameters and the index indicating relative order of the reordered audio object positions.

The above processing steps of arranging the positions of the audio objects to have an order such that the arranged azimuth values of the audio objects correspond to the closest to the azimuth values of the derived directions and indexing the positions of all but the first audio object are shown in FIG. 4 as steps 407 and 409 respectively.

The K bits used to scalar quantise the azimuth of the first object ϕ₀, which can be termed I_{ϕ}_{₀}, and the Index, Iᵣₒ representing the order of indices of the audio direction parameters of the audio objects 1 to N−1 can be form part of an encoded bitstream such as that from the encoder 100.

In some embodiments the scalar quantised elevation of the first object θₒ may also form part of the encoded bitstream.

As mentioned above the rotated derived audio direction vector [symbol] can be a “template” from which an audio direction difference vector can be derived for the audio direction parameter of each audio object. This may be performed for instance by the difference determiner 207 in FIG. 2. In embodiments the audio direction difference vector can be a 2-dimensional vector having an elevation difference value and an azimuth difference value.

It is to be appreciated that difference determiner may formulate the rotated derived audio direction vector [symbol] in terms of the quantised the azimuth of the first object ϕ₀′ in order to determine the audio difference vector.

For instance, the audio direction difference vector for an audio object P_{q} with directional components (θ_{q}, ϕ_{q}) can be found as

(Δθ_{q},Δϕ_{q})=(θ_{q}−\hat{θ}_{q},ϕ_{q}− [symbol] )

In practice however in some embodiments, Δθ_{q} may be θ_{q} because the elevation components of the above SP codevector can be zero. However, it is to be understood that other embodiments may derive a vector SP in which the elevation component is not zero, in these embodiments an equivalent rotation change may be applied to the elevation component of each element of the derived vector SP. That is the elevation component of each element of the derived vector SP may be rotated by (or aligned to) the first audio object's elevation.

It is to be understood that the directional difference for an audio object P_{q} is formed based on the difference between each element of the rotated derived audio direction vector [symbol] and the corresponding reordered (or repositioned) audio objects.

It is to be further understood that the above description has been laid out in terms of repositioning (or rearranging) the order of the audio objects however the above description is equally valid for the repositioning of just the audio direction parameters rather than the repositioning of the whole audio objects.

The step of forming the directional difference between each repositioned audio direction parameter and the corresponding rotated derived direction parameter is shown in FIG. 4 as processing step 411

The directional difference vector (Δθ_{q},Δϕ_{q}) associated with each audio object may then be quantised by a spherical quantizer & indexer 209.

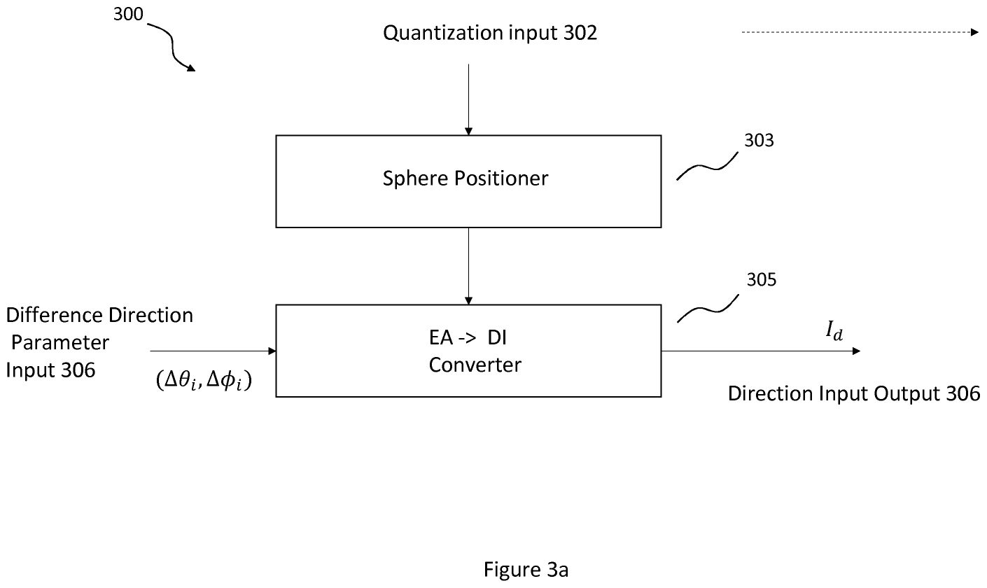

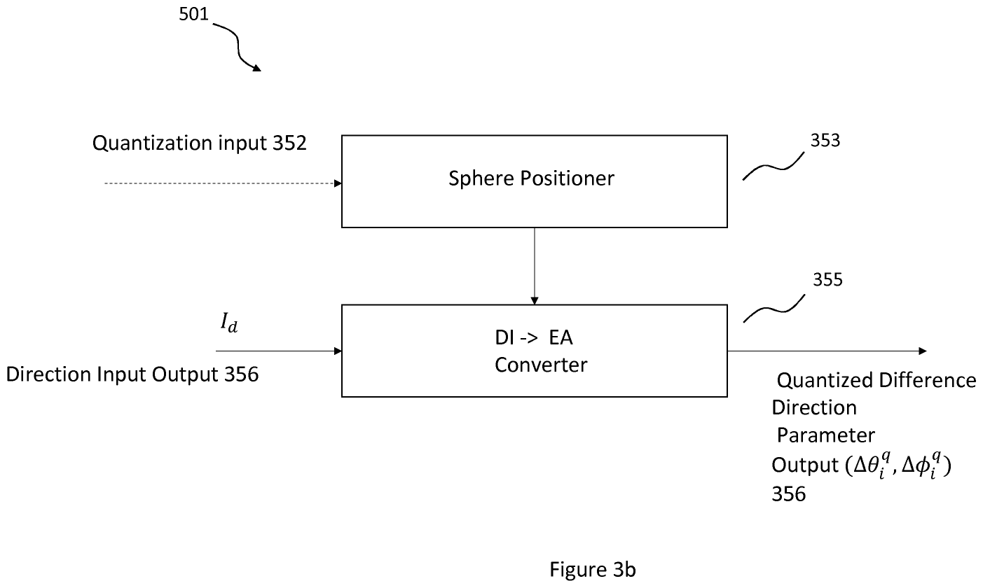

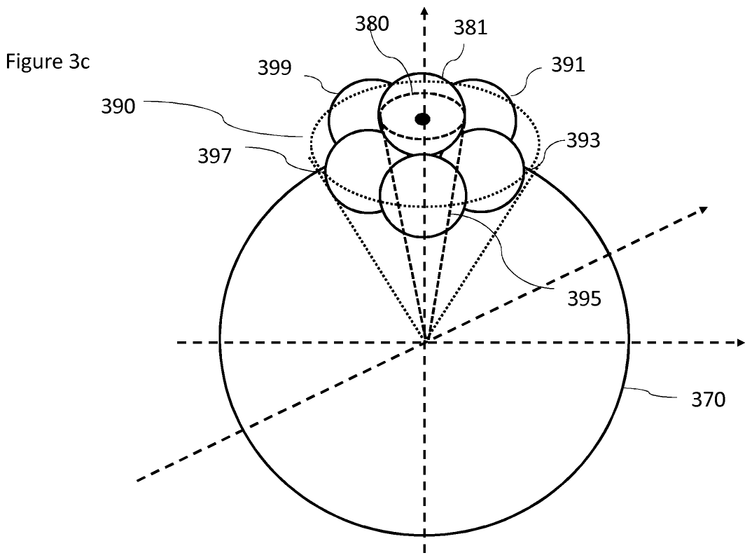

The spherical quantizer & indexer 209 is shown in more detail in FIG. 3a where the directional difference vector 210 is shown as being passed to the spherical quantizer 300 via the input 308.

The following section describes a suitable spherical quantization scheme for indexing the directional difference vector (Δθ_{q},Δϕ_{q}) for each audio object.

In the following text the input to the quantizer is generally referred to as (θ,ϕ) in order to simplify the nomenclature and because the method can be used for any elevation azimuth pair.

The direction spherical quantizer 300 in some embodiments comprises a quantization input 302. The quantization input, which may also be known as an encoding input is configured to define the granularity of spheres arranged around a reference location or position from which the direction parameter is determined. In some embodiments the quantization input is a predefined or fixed value. Furthermore, in some embodiments the quantization input 302 may define other aspects or inputs which may enable the configuration of the spherical quantization operations. For example, in some embodiments the quantization input 302 comprises a reference direction (for example relative to an absolute direction such as magnetic north). In some embodiments the reference direction is determined or defined based on an analysis of the input signals.

The direction spherical quantizer 300 in some embodiments comprises a sphere positioner 303. The sphere positioner is configured to configure the arrangement of spheres based on the quantization input value. The proposed spherical grid uses the idea of covering a sphere with smaller spheres and considering the centres of the smaller spheres as points defining a grid of almost equidistant directions.

The concept as shown herein is one in which a sphere is defined relative to the reference location and a reference direction. The sphere can be visualised as a series of circles (or intersections) and for each circle intersection there are located at the circumference of the circle a defined number of (smaller) spheres. This is shown for example with respect to FIG. 3c. For example, FIG. 3c shows an example ‘polar’ reference direction configuration which shows a first main sphere 370 which has a radius defined as the main sphere radius. Also shown in FIG. 3c are the smaller spheres (shown as circles) 381, 391, 393, 395, 397 and 399 located such that each smaller sphere has a circumference which at one point touches the main sphere circumference and at least one further point which touches at least one further smaller sphere circumference. Thus, as shown in FIG. 3c the smaller sphere 381, touches main sphere 370 and smaller spheres 391, 393, 395, 397, and 399. Furthermore, smaller sphere 381 is located such that the centre of the smaller sphere is located on the +/−90 degree elevation line (the z-axis) extending through the main sphere 370 centre.

The smaller spheres 391, 393, 395, 397 and 399 are located such that they each touch the main sphere 370, the smaller sphere 381 and additionally a pair of adjacent smaller spheres. For example the smaller sphere 391 additionally touches adjacent smaller spheres 399 and 393, the smaller sphere 393 additionally touches adjacent smaller spheres 391 and 395, the smaller sphere 395 additionally touches adjacent smaller spheres 393 and 397, the smaller sphere 397 additionally touches adjacent smaller spheres 399 and 391, and the smaller sphere 399 additionally touches adjacent smaller spheres 397 and 391.

The smaller sphere 381 therefore defines a cone 380 or solid angle about the +90 degree elevation line and the smaller spheres 391, 393, 395, 397 and 399 define a further cone 390 or solid angle about the +90 degree elevation line, wherein the further cone is a larger solid angle than the cone.

In other words the smaller sphere 381 (which defines a first circle of spheres) may be considered to be located at a first elevation (with the smaller sphere centre +90 degrees), and the smaller spheres 391, 393, 395, 397 and 399 (which define a second circle of spheres) may be considered to be located a second elevation (with the smaller sphere centres <90 degrees) relative to the main sphere and with an elevation lower than the preceding circle.

This arrangement may then be further repeated with further circles of touching spheres located at further elevations relative to the main sphere and with an elevation lower than the preceding circles.

The sphere positioner 303 thus in some embodiments be configured to perform the following operations to define the directions corresponding to the covering spheres:

Input: angle resolution for elevation, ∂θ
$( ideally such that \frac{π}{2 \partial θ} is interger )$
Output: number of circles, Nc, and number of points on each circle,
n(i), i =0,Nc-1

| | |
|---|---|
| 1. | n(0) = 1 |
| 2. | $M = [ \frac{π}{2 \partial θ} ]$ |
| 3. | For i =1:M-1 |
| | $a . n ( i ) = π sin ( \partial θ \cdot i ) / sin \frac{\partial θ}{2}$ |
| | $b . θ ( i ) = \frac{π}{2} - i \cdot \partial θ ( elevation )$ |
| | c. ∂ϕ(I) = 2 π/n(i) |
| | d. If i is odd |
| | i. ϕᵢ(0) = 0 |
| | e. Else |
| | $i . {ϕ}_{i} ( 0 ) = \frac{\partial ϕ ( i )}{2} ( first azimuth value on circle i )$ |
| | f. End if |
| 4. | End for |

Thus, according to the above the elevation for each point on the circle i is given by the values in θ(i). For each circle above the Equator there is a corresponding circle under the Equator (the plane defined by the X-Y axes).

Furthermore, as discussed above each direction point on one circle can be indexed in increasing order with respect to the azimuth value. The index of the first point in each circle is given by an offset that can be deduced from the number of points on each circle, n(i). In order to obtain the offsets, for a considered order of the circles, the offsets are calculated as the cumulated number of points on the circles for the given order, starting with the value 0 as first offset.

In other words, the circles are ordered starting from the “North Pole” downwards.

In another embodiment the number of points along the circles parallel to the Equator

$$n ( i ) = π sin ( \partial θ \cdot i ) / sin \frac{\partial θ}{2}$$

can also be obtained by

$$n ( i ) = π sin ( \partial θ \cdot i ) \text{/} ( {λ}_{i} sin \frac{\partial θ}{2} ) ,$$

where λᵢ≥1, λᵢ≤λᵢ₊₁. In other words, the spheres along the circles parallel to the Equator have larger radii as they are further away from the North pole, i.e. they are further away from North pole of the main direction.

The sphere positioner having determined the number of circles and the number of circles, Nc, number of points on each circle, n(i), i=0, Nc−1 and the indexing order can be configured to pass this information to an EA to DI converter 305.

The transformation procedures from (elevation/azimuth) (EA) to direction index (DI) and back are presented in the following paragraphs. The alternative ordering of the circles is considered here.

The direction metadata encoder 300 comprises an elevation-azimuth to direction index (EA-DI) converter 305. The elevation-azimuth to direction index converter 305 in some embodiments is configured to receive the direction parameter input 108 and the sphere positioner information and convert the elevation-azimuth value from the direction parameter input 108 to a direction index by quantizing the elevation-azimuth value.

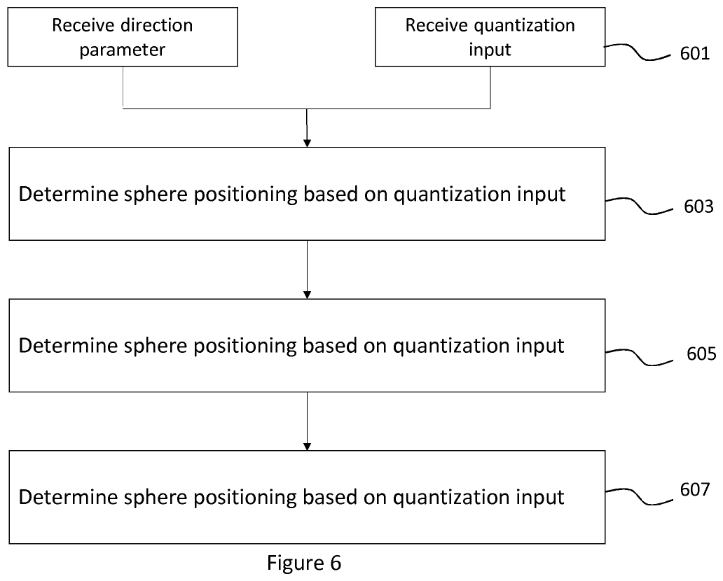

With respect to FIG. 6 an example method for generating the direction index according to some embodiments is shown.

The receiving of the quantization input is shown in FIG. 6 by step 601.

Then the method may determine sphere positioning based on the quantization input as shown in FIG. 6 by step 603.

Also, the method may comprise receiving the direction parameter as shown in FIG. 6 by step 602.

Having received the direction parameter and the sphere positioning information the method may comprise converting the direction parameter to a direction index based on the sphere positioning information as shown in FIG. 6 by step 605.

The method may then output the direction index as shown in FIG. 6 by step 607.

In some embodiments the elevation-azimuth to direction index (EA-DI) converter 305 is configured to perform this conversion according to the following algorithm:

$$Input \text{:} ( θ , ϕ ) , θ ∈ {S}_{θ} ⋐ [ - \frac{π}{2} , \frac{π}{2} ] , ϕ ∈ {S}_{ϕ} ⋐ [ 0 , 2 π ]$$

$$Output \text{:} {I}_{d}$$

In some embodiments S_{θ} may take the form of an indexed codebook with N discrete entries, each entry θₗ corresponding to a value of elevation for l=0:N−1. Additionally, the codebook also comprises for each discrete elevation value θₗ a set of discrete azimuth values ϕₘ where the number of azimuth values in the set is dependent in the elevation θₗ. In other words for each elevation entry θₗ there can be differing numbers of discrete azimuth values ϕₘ for j=0: f(θₗ), where f (θₗ) denotes that number of azimuth values in the set of azimuth values associated with the elevation value θₗ is a function of the elevation value θₗ.

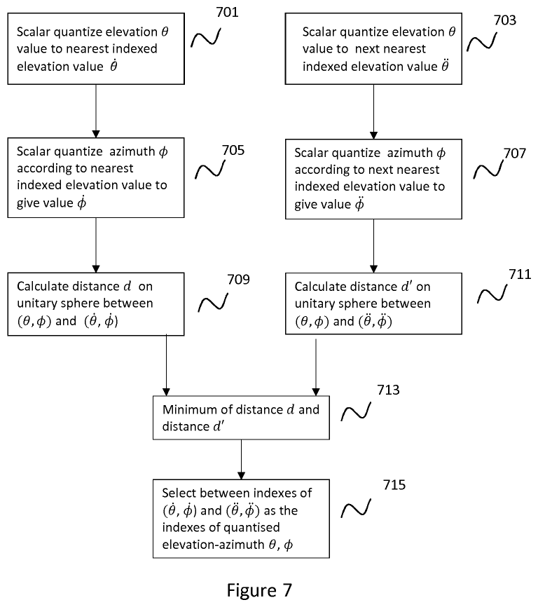

With respect to FIG. 7 an example method is shown of the step 605 in FIG. 6 for converting elevation-azimuth to direction index (EA-DI).

The first step of quantizing an elevation-azimuth value may comprise scalar quantising the elevation value θ by finding the closest codebook entry θₗ to give a first quantised elevation value \dot{θ}=θₗ. The elevation value θ can again be scalar quantized by finding the next closest codebook entry. This may be given as either of the codebook entries θₗ₊₁ or θₗ₋₁ depending on which one is closer to θ thereby producing a second quantised elevation value \ddot{θ}.

The processing steps of Scalar quantizing the elevation θ value to the nearest indexed elevation value θᵢ and additionally to the next closest indexed elevation value θₗ₊₁ or θₗ₋₁ are shown as processing steps 701 and 703 respectively.

For each quantised elevation value \dot{θ} and \ddot{θ} the corresponding scalar quantized azimuth value can be found. In other words a first scalar quantized azimuth value corresponding to \dot{θ} can be determined by finding the nearest azimuth value from the set of azimuth values associated with the indexed elevation value θₗ for the first quantized elevation value \dot{θ}. The first scalar quantized azimuth value corresponding to the first quantized elevation value \dot{θ} may be expressed as \dot{ϕ}. Similarly, a second scalar quantized azimuth value corresponding to \ddot{θ} can also be determined and expressed as \ddot{ϕ}. This can be performed by re-quantising the azimuth value ϕ, however but this time using the set of azimuth values associated with the index of the second scalar quantized elevation value \ddot{θ}.

The processing steps of Scalar quantizing the azimuth value ϕ corresponding to the nearest indexed elevation value θₗ and additionally scalar quantizing the azimuth value corresponding to the next closest indexed elevation value θₗ₊₁ or θₗ₋₁ are shown as processing steps 705 and 707 respectively.

Once the first elevation-azimuth scalar quantized pair of values and the second elevation-azimuth scalar quantized pair of values have been determined a distance measure on a unitary sphere for each pair may be calculated. The distance measure can be considered by taking the L2 norm distance between two points on the unitary sphere, so for the first scalar quantized elevation-azimuth pair (\dot{θ}, \dot{ϕ})) the distance d is calculated as the distance between the first scalar quantized elevation-azimuth pair (\dot{θ}, \dot{ϕ})) and the un-quantised elevation-azimuth pair (θ,ϕ) on the unitary sphere. Similarly, for the second scalar quantized elevation-azimuth pair (\hat{θ},\ddot{ϕ}) the distance d′ is calculated as the distance between the second scalar quantized elevation-azimuth pair (\ddot{θ}, \ddot{ϕ}) and the un-quantised elevation-azimuth pair (θ, ϕ) on the unitary sphere.

It is to be appreciated in embodiments that the L2 norm distance between two points x and y on a unitary sphere may be considered from ∥x−y∥² where x and y are spherical coordinates in three dimensional space. In terms the elevation-azimuth pair (θ,ϕ) the spherical coordinates can be expressed as x=(r cos(θ) cos(ϕ), r cos(θ) sin(ϕ), r sin(θ)) and for the elevation-azimuth (\dot{θ}, \dot{ϕ})) pair the spherical coordinates correspond to y=(r cos(\dot{θ})cos(\dot{ϕ}),r cos(\dot{θ})sin(\dot{ϕ}),r sin(\dot{θ})). By considering a unitary sphere the radius r=1, and the distance d can be reduced to the calculation d=−(sin(θ) sin(\dot{θ})+cos(θ)cos(\dot{θ})cos(ϕ−\dot{ϕ})), where it can be seen that the distance d is solely dependent on the values of the angles.

Similarly the distance d′ between the second scalar quantized elevation-azimuth pair (\ddot{θ}, \ddot{ϕ}) and the un-quantised elevation-azimuth pair (θ, ϕ)) on the unitary sphere can be expressed as d′=—(sin(θ)sin(\ddot{θ})+cos(θ) cos(\ddot{θ}) cos (ϕ−\ddot{ϕ})).

The processing step of finding the distance between the first scalar quantized elevation-azimuth pair (\ddot{θ}, \ddot{ϕ}) and the un-quantised elevation-azimuth pair (θ, ϕ)) is shown as 709 in FIG. 7.

The processing step of finding the distance between the second scalar quantized elevation-azimuth pair (\ddot{θ}, \ddot{φ}) and the un-quantised elevation-azimuth pair (θ, ϕ)) is shown as 711 in FIG. 7.

Finally, the scalar quantized elevation-azimuth pair which has a minimum distance measure is selected as the quantized elevation-azimuth values for the elevation-azimuth (θ, ϕ)). The corresponding indices associated with the selected quantized elevation and azimuth pair then go onto form the direction index I_{d}.

The processing step of finding the minimum distance is shown in FIG. 7 as 713.

The processing step of selecting between indexes of (\dot{θ}, \dot{ϕ})) and (\ddot{θ}, \ddot{ϕ}) has the indexes of quantised elevation-azimuth θ, ϕ in accordance with the minimum distance is shown as 715 in FIG. 7.

It is to be appreciated that even though the above spherical quantization scheme has been defined in terms of a unitary sphere, other embodiments may deploy the above quantization scheme based on a general sphere whose radius is not equal to one. In such embodiments the above step of finding the minimum distance still holds since the minimum distance calculation corresponding to both the first scalar quantized elevation-azimuth pair and second scalar quantized elevation pair is independent or the radius r.

In another embodiments it is also possible to quantize the elevation and the azimuth using scalar quantizers. Irrespective of which of the spherical grid or scalar quantizers are used for the quantization of the azimuth and elevation, the azimuth and elevation resulting indexes can be used for encoding and transmission instead of the direction index. This may be particularly useful in instances where there is saving in the bit consumption

The direction index I_{d} 306 may be output.

Returning to FIG. 4 the overall step of quantising the audio direction differences is shown is depicted as processing step 413.

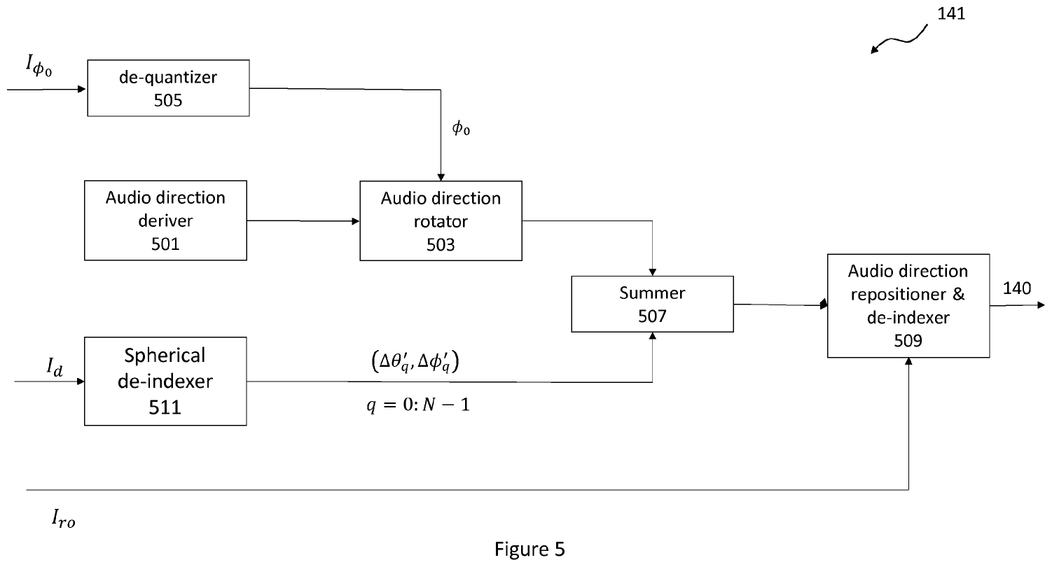

With respect to FIG. 5 there is shown a audio object decoder according to 141 in FIG. 1. As can be seen the audio object decoder 141 can be arranged to receive from the encoded bitstream the direction index I_{d}, the K bits used to scalar quantise the azimuth of the first object ϕ₀, which is termed I_{ϕ}_{₀}, and the Index, Iᵣₒ representing the order of indices of the audio direction parameters of the audio objects 1 to N−1. Within the audio object decoder 141 the direction index I_{d} may be passed to the spherical de-indexer 511. In that regard there is shown in FIG. 3b an example spherical de-indexer 511 which can be used to decode the direction data index I_{d} associated with an audio object and produce the quantised directional difference vectors

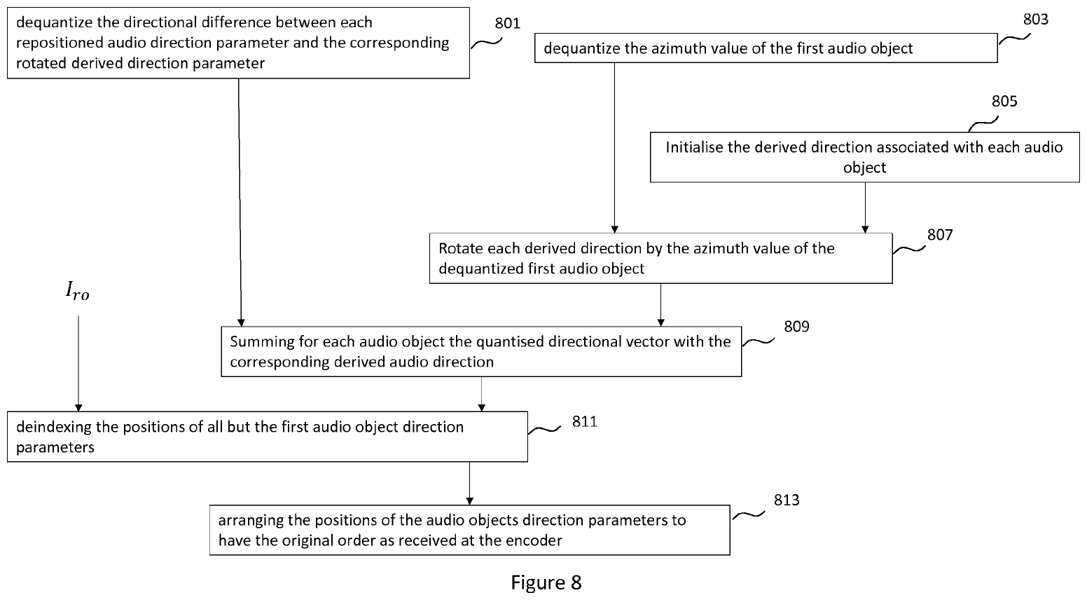

Associated with FIG. 5 there is FIG. 8 which depicts the processing steps of the audio object decoder 141.

From herein the nomenclature of the audio difference direction vector is reverted back to (Δθ_{q}, Δϕ_{q}) and the quantized audio difference direction vector shall be referred to as (Δθ′_{q}, Δϕ′_{q})

The spherical de-indexer 511 may comprise a quantization input 352. This in some embodiments is passed from the encoder or is otherwise agreed with the encoder.

The quantization input is configured to define the granularity of spheres arranged around a reference location or position. Furthermore, in some embodiments the quantization input defines configuration of the spheres, for example orientation of the reference direction (relative to an absolute direction such as magnetic north).

The spherical de-indexer 511 can comprise a direction index input 351. This can be received from the encoder or retrieved by any suitable means.

The spherical de-indexer directional 511 in some embodiments comprises a sphere positioner 353. The sphere positioner 353 is configured to receive as an input the quantization input and generate the sphere arrangement in the same manner as generated in the encoder. The sphere arrangement is then used to generate the codebook as described earlier for generating the dequantized elevation and azimuth values.

The spherical de-indexer 511 comprises a direction index to elevation-azimuth (DI-EA) converter 355. The direction index to elevation-azimuth converter 355 is configured to receive the direction index and furthermore the spherical codebook as generated by the sphere arrangement. The index to elevation-azimuth converter 355 then converts the direction index to quantised elevation and azimuth values by referencing the index to the spherical codebook and retrieving the corresponding quantised elevation and azimuth values.

As discussed previously the above spherical quantisation scheme can be arranged to quantise and index the directional difference vector corresponding to an audio object P_{q}. As alluded to previously the quantisation and dequantisation of the directional difference vectors are performed on a directional vector by directional vector basis for each audio object in turn. Therefore, the end of result of the spherical dequantisation process may be N quantised directional difference vectors (Δθ′_{q},Δϕ′_{q}) corresponding each to an audio object P_{q} q=0: N−1.

The step of dequantizing the audio direction difference between each repositioned audio direction parameter and the corresponding rotated derived audio direction parameter is depicted in FIG. 8 as processing step 801.

Additionally, FIG. 5 shows the index I_{ϕ}_{₀}, the K bits used to scalar quantise the azimuth of the first object ϕ₀, being passed to the dequantizer 505 in order to produce the dequantised first object azimuth angle ϕ′₀. The step of dequantising the azimuth value of the first audio object is shown as processing step 803 in FIG. 8.

The audio object decoder 141 can comprise an audio direction deriver 501 which has the same function as the audio direction deriver 201 at the encoder 121. In other words, audio direction deriver 501 can be arranged to form and initialise an SP vector in the same manner as that performed at the encoder. That is each derived audio direction component of the SP vector is formed under the premise that the directional information of the audio objects can be initialised as a series of points evenly distributed along the circumference of a unit circle starting at an azimuth value of 0°. The SP vector containing the derived audio directions may then be passed to the audio direction rotator 503.

With reference to FIG. 8 the step of initialising the derived direction associated with each audio object is shown as processing step 807.

The audio direction rotator 503 can also be arranged to accept as a further input the dequantized azimuth of the first object ϕ′₀. The dequantized azimuth value of the first object can be used by audio direction rotator 503 to reform the rotated derived audio direction “template” vector [symbol] =(\hat{ϕ}₀′; \hat{ϕ}₁′; \hat{ϕ}₂′; . . . ; \hat{ϕ}_{N-1}′) for the N−1 audio object directions by using the following calculation

$$= ( 0 , 0 + {ϕ}_{0}^{′} ; 0 , \frac{360}{N} + {ϕ}_{0}^{′} ; 0 , 2 \cdot \frac{360}{N} + {ϕ}_{0}^{′} ; … ; 0 , ( N - 1 ) \cdot \frac{360}{N} + {ϕ}_{0}^{′} ) .$$

In other words, rotated derived vector [symbol] is formed by adding the dequantized azimuth of the first object ϕ′₀ to each derived audio direction component of the SP vector.

With reference to FIG. 8 the processing step 807 represents the rotating of each derived direction by the azimuth value of the dequantized first audio object.

The rotated derived audio directions may then be passed to a summer 507.

Having decoded the N directional difference vector indexes associated with the N audio objects in processing step 801, the quantised audio direction difference vector (Δθ′_{q}, Δϕ′_{q}) corresponding to the audio objects P_{q} q=0: N−1 may also be passed to the summer 507 for further processing.

The summer 507 can be arranged to form the quantised directional vector for each audio object by summing for each audio object P_{q} q=0: N−1 the quantised directional vector (Δθ′_{q},Δϕ′_{q}) with the corresponding rotated derived audio direction

$$0 , q \cdot \frac{360}{N} + {ϕ}_{0}^{′}$$

(from the dequantized rotated derived audio direction “template” vector [symbol] ′.) This can be expressed as.

(θ′_{q},ϕ′_{q})=(Δθ_{q}′+\hat{θ}_{q}′,Δϕ_{q}′+ [symbol] ′)q=0:N−1

For those embodiments in which a rotation is solely based on the azimuth value, that is the elevation component is 0 for each element of the “template” codevector SP the above equation reduces to

(θ′_{q},ϕ′_{q})=(Δθ_{q}′,Δϕ_{q}′+ [symbol] ′)q=0:N−1

The processing step of summing for each audio object P_{q} q=0: N−1 the quantised directional vector (Δθ′_{q},Δϕ′_{q}) with the corresponding rotated derived audio direction is shown in FIG. 8 as step 809.

Returning to FIG. 5, the Index, Iᵣₒ representing the order of indices of the audio direction parameters of the audio objects 1 to N−1 is shown as being received by the audio direction de-indexer and re-positioner 509. In addition, the audio direction de-indexer and re-positioner 509 can also be arranged to receive the N quantised audio direction vectors from the summer 507.

In embodiments the audio direction de-indexer and re-positioner 509 can be configured to decode the index Iᵣₒ in order to find the particular permutation of indices of the re-ordered audio directions. This permutation of indices may then be used by the audio direction de-indexer and re-positioner 509 to reorder the audio direction parameters back to their original order, as first presented to the audio object encoder 121. The output from audio direction de-indexer and re-positioner 509 may therefore be the ordered quantised audio directions associated with the N audio objects. These ordered quantised audio parameters may then form part of the decoded multiple audio object stream 140.

The step of deindexing the positions of all but the first audio object direction parameters is shown as processing step 811 in FIG. 8.

The step of arranging the positions of the audio objects direction parameters to have the original order as received at the encoder is shown as processing step 813 in FIG. 8.

With respect to FIG. 10 an example electronic device which may be used as the analysis or synthesis device is shown. The device may be any suitable electronics device or apparatus. For example, in some embodiments the device 1400 is a mobile device, user equipment, tablet computer, computer, audio playback apparatus, etc.

In some embodiments the device 1400 comprises at least one processor or central processing unit 1407. The processor 1407 can be configured to execute various program codes such as the methods such as described herein.

In some embodiments the device 1400 comprises a memory 1411. In some embodiments the at least one processor 1407 is coupled to the memory 1411. The memory 1411 can be any suitable storage means. In some embodiments the memory 1411 comprises a program code section for storing program codes implementable upon the processor 1407. Furthermore, in some embodiments the memory 1411 can further comprise a stored data section for storing data, for example data that has been processed or to be processed in accordance with the embodiments as described herein. The implemented program code stored within the program code section and the data stored within the stored data section can be retrieved by the processor 1407 whenever needed via the memory-processor coupling.

In some embodiments the device 1400 comprises a user interface 1405. The user interface 1405 can be coupled in some embodiments to the processor 1407. In some embodiments the processor 1407 can control the operation of the user interface 1405 and receive inputs from the user interface 1405. In some embodiments the user interface 1405 can enable a user to input commands to the device 1400, for example via a keypad. In some embodiments the user interface 1405 can enable the user to obtain information from the device 1400. For example the user interface 1405 may comprise a display configured to display information from the device 1400 to the user. The user interface 1405 can in some embodiments comprise a touch screen or touch interface capable of both enabling information to be entered to the device 1400 and further displaying information to the user of the device 1400. In some embodiments the user interface 1405 may be the user interface for communicating with the position determiner as described herein.

In some embodiments the device 1400 comprises an input/output port 1409. The input/output port 1409 in some embodiments comprises a transceiver. The transceiver in such embodiments can be coupled to the processor 1407 and configured to enable a communication with other apparatus or electronic devices, for example via a wireless communications network. The transceiver or any suitable transceiver or transmitter and/or receiver means can in some embodiments be configured to communicate with other electronic devices or apparatus via a wire or wired coupling.

The transceiver can communicate with further apparatus by any suitable known communications protocol. For example in some embodiments the transceiver or transceiver means can use a suitable universal mobile telecommunications system (UMTS) protocol, a wireless local area network (WLAN) protocol such as for example IEEE 802.X, a suitable short-range radio frequency communication protocol such as Bluetooth, or infrared data communication pathway (IRDA).

The transceiver input/output port 1409 may be configured to receive the signals and in some embodiments determine the parameters as described herein by using the processor 1407 executing suitable code. Furthermore the device may generate a suitable downmix signal and parameter output to be transmitted to the synthesis device.

In some embodiments the device 1400 may be employed as at least part of the synthesis device. As such the input/output port 1409 may be configured to receive the downmix signals and in some embodiments the parameters determined at the capture device or processing device as described herein, and generate a suitable audio signal format output by using the processor 1407 executing suitable code.

The input/output port 1409 may be coupled to any suitable audio output for example to a multichannel speaker system and/or headphones or similar.

In general, the various embodiments of the invention may be implemented in hardware or special purpose circuits, software, logic or any combination thereof.

For example, some aspects may be implemented in hardware, while other aspects may be implemented in firmware or software which may be executed by a controller, microprocessor or other computing device, although the invention is not limited thereto. While various aspects of the invention may be illustrated and described as block diagrams, flow charts, or using some other pictorial representation, it is well understood that these blocks, apparatus, systems, techniques or methods described herein may be implemented in, as non-limiting examples, hardware, software, firmware, special purpose circuits or logic, general purpose hardware or controller or other computing devices, or some combination thereof.

The embodiments of this invention may be implemented by computer software executable by a data processor of the mobile device, such as in the processor entity, or by hardware, or by a combination of software and hardware. Further in this regard it should be noted that any blocks of the logic flow as in the Figures may represent program steps, or interconnected logic circuits, blocks and functions, or a combination of program steps and logic circuits, blocks and functions. The software may be stored on such physical media as memory chips, or memory blocks implemented within the processor, magnetic media such as hard disk or floppy disks, and optical media such as for example DVD and the data variants thereof, CD.

The memory may be of any type suitable to the local technical environment and may be implemented using any suitable data storage technology, such as semiconductor-based memory devices, magnetic memory devices and systems, optical memory devices and systems, fixed memory and removable memory. The data processors may be of any type suitable to the local technical environment, and may include one or more of general purpose computers, special purpose computers, microprocessors, digital signal processors (DSPs), application specific integrated circuits (ASIC), gate level circuits and processors based on multi-core processor architecture, as non-limiting examples.

Embodiments of the inventions may be practiced in various components such as integrated circuit modules. The design of integrated circuits is by and large a highly automated process. Complex and powerful software tools are available for converting a logic level design into a semiconductor circuit design ready to be etched and formed on a semiconductor substrate.

Programs can automatically route conductors and locate components on a semiconductor chip using well established rules of design as well as libraries of pre-stored design modules. Once the design for a semiconductor circuit has been completed, the resultant design, in a standardized electronic format (e.g., Opus, GDSII, or the like) may be transmitted to a semiconductor fabrication facility or “fab” for fabrication.

The foregoing description has provided by way of exemplary and non-limiting examples a full and informative description of the exemplary embodiment of this invention. However, various modifications and adaptations may become apparent to those skilled in the relevant arts in view of the foregoing description, when read in conjunction with the accompanying drawings and the appended claims. However, all such and similar modifications of the teachings of this invention will still fall within the scope of this invention as defined in the appended claims.

1-32. (canceled)

33. An apparatus comprising at least one processor and at least one memory including computer program code, the at least one memory and the computer program code configured to, with the at least one processor cause the apparatus to:
derive for each of the plurality of audio direction parameters, wherein each parameter comprises an elevation value and an azimuth value and wherein each parameter has an ordered position, a corresponding derived audio direction parameter comprising an elevation value and an azimuth value;
rotate each derived audio direction parameter by the azimuth value of an audio direction parameter in the first position of the plurality of audio direction parameters;
change the ordered position of an audio direction parameter to a further position coinciding with a position of a rotated derived audio direction parameter when the azimuth value of the audio direction parameter is closest to the azimuth value of the further rotated derived audio direction parameter compared to the azimuth values of other rotated derived audio direction parameters, followed by the apparatus being configured to determine for each of the plurality audio direction parameters a difference between each audio direction parameter and a corresponding rotated derived audio direction parameter; and
quantize the difference for each of the plurality of audio direction parameters.

34. The apparatus, as claimed in claim 33, wherein the azimuth value of each derived audio direction parameter corresponds with a position of a plurality of positions around the circumference of a circle.

35. The apparatus, as claimed in claim 33, wherein the plurality of positions around the circumference of the circle are evenly distributed along the 360 degrees of the circle, and wherein the number of positions around the circumference of the circle is determined by the number of audio direction parameters.

36. The apparatus, as claimed in claim 33, wherein the apparatus caused to rotate each derived audio direction parameter by the azimuth value of a first audio direction parameter of the plurality of audio direction parameters is further caused to:
add the azimuth value of the first audio direction parameter to the azimuth value of each derived audio direction parameter, wherein the elevation value of each derived audio direction parameter is set to zero.

37. The apparatus, as claimed in claim 33, further caused to:
scalar quantize the azimuth value of the first audio direction parameter; and
index the positions of the audio direction parameters after the changing by the apparatus being caused to assign an index to a permutation of indices representing the order of the positions of the audio direction parameters.

38. The apparatus as claimed in claim 33, wherein the apparatus caused to determine for each of the plurality of audio direction parameters a difference between each audio direction parameter and a corresponding rotated derived audio direction parameter is caused to:
determine for each of the plurality of audio direction parameters a difference audio direction parameter based on at least;
determine a difference between the first positioned audio direction parameter and the first positioned rotated derived audio direction parameter, and/or determine a difference between a further audio direction parameter and a rotated derived audio direction parameter, wherein the position of the further audio direction parameter is unchanged, and/or determining a difference between a yet further audio direction parameter and a rotated derived audio direction parameter wherein the position of the yet further audio direction parameter has been changed to the position of the rotated derived audio direction parameter.

39. The apparatus as claimed in claim 33, wherein the apparatus caused to determine a difference between an audio direction parameter and a corresponding rotated derived audio direction parameter is caused to:
determine the difference between an azimuth value of the audio direction parameter and an azimuth value of the corresponding rotated derived audio direction parameter; and
determine the difference between an elevation value of the audio direction parameter and an elevation value of the corresponding rotated derived audio direction parameter.

40. The apparatus as claimed in claim 33, wherein the apparatus caused to change the position of an audio direction parameter to a further position applies to any audio direction parameter but the first positioned audio direction parameter.

41. The apparatus as claimed in claim 33, wherein the apparatus caused to quantize the difference audio direction parameter for each of the plurality of audio direction parameters is caused to quantize the difference audio direction parameter for each of the plurality of audio direction parameters as a vector, wherein the vector is indexed to a codebook comprising a plurality of indexed elevation values and indexed azimuth values.

42. The apparatus as claimed in claim 41, wherein the plurality of indexed elevation values and indexed azimuth values are points on a grid arranged in a form of a sphere, wherein the spherical grid is formed by covering the sphere with smaller spheres, wherein the smaller spheres define the points of the spherical grid.

43. An apparatus comprising at least one processor and at least one memory including computer program code, the at least one memory and the computer program code configured to, with the at least one processor cause the apparatus to:
decode an index to provide a quantized azimuth value of an audio direction parameter in a first position of a plurality of ordered audio direction parameters, wherein each parameter comprises an elevation value and an azimuth value;
derive for each of the plurality of audio direction parameters a corresponding derived audio direction parameter comprising an elevation value and an azimuth value;
rotate each derived audio direction parameter by the azimuth value of the audio direction parameter in the first position of the plurality of audio direction parameters;
decode an index to provide for each audio direction parameter a quantized difference between an audio direction parameter and their corresponding derived audio direction parameter;
form, for each audio direction parameter, a quantized audio direction parameter by adding the quantized difference to their corresponding derived audio direction parameter; and
decode an index representing an order for the plurality of quantized audio direction parameters and reordering the positions of the plurality of quantized audio direction parameters according to the order.

44. The apparatus as claimed in claim 43, wherein the azimuth value of each derived audio direction parameter corresponds with a position of a plurality of positions around the circumference of a circle.

45. The apparatus as claimed in claim 43, wherein the plurality of positions around the circumference of the circle are evenly distributed along the 360 degrees of the circle, and wherein the number of positions around the circumference of the circle is determined by the number of audio direction parameters.

46. The apparatus as claimed in claim 43, wherein the apparatus caused to rotate each derived audio direction parameter by the quantized azimuth value of a first audio direction parameter of the plurality of audio direction parameters is caused to:
add the quantized azimuth value of the first audio direction parameter to the azimuth value of each derived audio direction parameter, wherein the elevation value of each derived audio direction parameter is set to zero.

47. The apparatus as claimed in claim 43, wherein the index to provide for each audio direction parameter a quantized difference between an audio direction parameter and their corresponding derived audio direction parameter is an index to a codebook comprising a plurality of indexed elevation values and indexed azimuth values.

48. The apparatus as claimed in claim 47, wherein the plurality of indexed elevation values and indexed azimuth values are points on a grid arranged in a form of a sphere, wherein the spherical grid is formed by covering the sphere with smaller spheres, wherein the smaller spheres define the points of the spherical grid.

49. A method comprising: comprising:
deriving for each of the plurality of audio direction parameters, wherein each parameter comprises an elevation value and an azimuth value and wherein each parameter has an ordered position, a corresponding derived audio direction parameter comprising an elevation value and an azimuth value;
rotating each derived audio direction parameter by the azimuth value of an audio direction parameter in the first position of the plurality of audio direction parameters;
changing the ordered position of an audio direction parameter to a further position coinciding with a position of a rotated derived audio direction parameter when the azimuth value of the audio direction parameter is closest to the azimuth value of the further rotated derived audio direction parameter compared to the azimuth values of other rotated derived audio direction parameters, followed by determining for each of the plurality audio direction parameters a difference between each audio direction parameter and a corresponding rotated derived audio direction parameter; and
quantizing the difference for each of the plurality of audio direction parameters.

50. The method as claimed in claim 49, wherein the azimuth value of each derived audio direction parameter corresponds with a position of a plurality of positions around the circumference of a circle.

51. The method as claimed in claim 49, wherein the plurality of positions around the circumference of the circle are evenly distributed along the 360 degrees of the circle, and wherein the number of positions around the circumference of the circle is determined by the number of audio direction parameters.

52. The method as claimed in claim 49, wherein rotating each derived audio direction parameter by the azimuth value of a first audio direction parameter of the plurality of audio direction parameters comprises:
adding the azimuth value of the first audio direction parameter to the azimuth value of each derived audio direction parameter, wherein the elevation value of each derived audio direction parameter is set to zero.
